(19) United States
(12) Patent Application Publication
(10) Pub. No.: US 2026/0080415 A1
(43) Pub. Date: Mar. 19, 2026

(54) CO2 EMISSION CALCULATION SYSTEM, CO2 EMISSION CALCULATION METHOD, AND PROGRAM

(71) Applicant: LOGISTEED, LTD., Chuo-ku, Tokyo (JP)

(72) Inventor: Yasuhiro HANZAWA, Chuo-ku, Tokyo (JP)

(21) Appl. No.: 18/860,171

(22) PCT Filed: Apr. 28, 2022
(86) PCT No.: PCT/JP2022/019246

§ 371 Date: Jul. 7, 2025

(51) Int. Cl. G06Q 30/018; G06Q 10/083

(52) U.S. Cl. CPC G06Q 30/018; G06Q 10/083

(57) ABSTRACT

A CO₂ emission amount calculation system, a CO₂ emission calculation method, and a program is provided that accurately calculates CO₂ emissions related to logistics for each consignor. The CO₂ emission amount calculation system includes a first calculation unit that calculates a CO₂ emissions based on transportation cost for a material used for the logistics, and an identifying unit that identifies a consignor that produced the calculated CO₂ emissions. The CO₂ emission amount calculation system further includes a second calculation unit that calculates a CO₂ emissions based on energy consumed by transportation of an item, a third calculation unit that calculates a CO₂ emissions based on energy consumed by travel of the item in a warehouse site, and a fourth calculation unit that calculates a CO₂ emissions based on energy consumed by management of the item within the warehouse site.

### TECHNICAL FIELD

The present disclosure relates to a CO₂ emission calculation system, CO₂ emission calculation method, and a program that calculate CO₂ emissions related to logistics.

### BACKGROUND

Conventionally, a system for calculating CO₂ emissions related to logistics has been disclosed, which estimates the travel distance of a vehicle used for delivering an item based on the vehicle registration number and calculates CO₂ emissions based on this travel distance (Patent Document 1). Additionally, a system has been disclosed, which calculates CO₂ emissions based on electricity consumed in a warehouse where an item is stored (Patent Document 2).

### DOCUMENT IN THE EXISTING ART

### Patent Document

Patent Document 1: JP2009-230740 A
Patent Document 2: JP2012-108691 A

### SUMMARY

### The Technical Problem Solved by the Disclosure

In recent years, there has been an increase in cases where a company that outsources merchandise logistics to a specialized vendor requests CO₂ reduction as part of the company's environmental measures. Therefore, it has become necessary to calculate CO₂ emissions first. However, since a specialized vendor handles logistics for multiple consignors, it has been difficult to accurately understand CO₂ emissions for each consignor.

Therefore, the present disclosure provides a CO₂ emission calculation system, a CO₂ emission calculation method, and a program that accurately calculate CO₂ emissions related to logistics for each consignor.

### Solution for Solving the Technical Problem

The present disclosure provides a CO₂ emission calculation system that calculates CO₂ emissions related to logistics, including: a first calculation unit that calculates CO₂ emissions based on a transportation cost for a material used for the logistics and an identifying unit that identifies a consignor that produced the calculated CO₂ emissions.

The present disclosure also provides the CO₂ emission calculation system, in which the first calculation unit calculates CO₂ emissions for each payment department that manages trade for the material, and the identifying unit identifies a consignor that produced the calculated CO₂ emissions based on department information containing the consignor assigned to each the payment department.

The present disclosure also provides the CO₂ emission calculation system, further including: a second calculation unit that calculates CO₂ emissions based on energy consumed by transportation of an item, a third calculation unit that calculates CO₂ emissions based on energy consumed by travel of an item in a warehouse site, and a fourth calculation unit that calculates CO₂ emissions based on energy consumed by management of the item in the warehouse site, in which the identifying unit identifies a consignor that produced the CO₂ emissions calculated by each of the calculation units.

The present disclosure also provides the CO₂ emission calculation system, in which the second calculation unit calculates CO₂ emissions for each the item, the third calculation unit calculates CO₂ emissions for each vehicle used in travel of the item, and the fourth calculation unit calculates CO₂ emissions for each recording department that recorded energy consumed by management of the item, the identifying unit identifies a consignor that produced CO₂ emissions calculated by the second calculation unit based on shipping information containing a consignor for each the item, identifies a consignor that produced CO₂ emissions calculated by the third calculation unit based on vehicle information containing a consignor for each the vehicle, and identifies a consignor that produced CO₂ emissions calculated by the fourth calculation unit based on recording department information containing a consignor for each the recording department assigned to the consignor.

The present disclosure also provides the CO₂ emission calculation system, in which the second calculation unit acquires information on the consumed energy from a device installed in a vehicle used for transportation of the item, and/or the third calculation unit acquires information on the consumed energy from a device installed in a vehicle used for travel of the item.

The present disclosure also provides the CO₂ emission calculation system, further including a display unit that displays CO₂ emissions produced at a base based on base information of the identified consignor.

The present disclosure also provides a CO₂ emission calculation method of executing a CO₂ emission calculation system that calculates CO₂ emissions related to logistics, including the steps of: calculating CO₂ emissions based on a transportation cost for a material used for the logistics and identifying a consignor that produced the calculated CO₂ emissions.

The present disclosure provides a program causing a CO₂ emission calculation system that calculates CO₂ emissions related to logistics to function as: a first calculation unit that calculates CO₂ emissions based on a transportation cost for a material used for the logistics; and an identifying unit that identifies a consignor that produced the calculated CO₂ emissions.

### Technical Effect

The present disclosure can accurately calculate CO₂ emissions related to logistics for each consignor.

### BRIEF DESCRIPTION OF THE DRAWINGS

FIG. 1 is a diagram explaining the overview of the CO₂ emission calculation system according to an Embodiment of the present disclosure.

FIG. 2 is a diagram showing the functional configuration of the CO₂ emission calculation device according to an embodiment of the present disclosure.

FIG. 3 is a flowchart of the CO₂ emission calculation process of the first calculation unit according to an embodiment of the present disclosure.

FIG. 4 is a diagram schematically showing trade information according to an embodiment of the present disclosure.

FIG. 5 is a flowchart of the CO₂ emission calculation process of the second calculation unit according to an embodiment of the present disclosure.

FIG. 6 is a diagram schematically showing ship notice information according to an embodiment of the present disclosure.

FIG. 7 is a flowchart of the CO₂ emission calculation process of the third calculation unit according to an embodiment of the present disclosure.

FIG. 8 is a diagram schematically showing operation information according to an embodiment of the present disclosure.

FIG. 9 is a flowchart of the CO₂ emission calculation process of the fourth calculation unit according to an embodiment of the present disclosure.

FIG. 10 is a diagram schematically showing electricity consumption information according to an embodiment of the present disclosure.

FIG. 11 is a flowchart of the CO₂ emission calculation process of the CO₂ emission calculation system according to an embodiment of the present disclosure.

FIG. 12 shows an example display on a consignor terminal according to an embodiment of the present disclosure.

### DETAILED DESCRIPTION OF THE EMBODIMENTS

Hereinafter, embodiments to carry out the present disclosure (hereinafter referred to as “Embodiments”) are described below in detail with reference to the attached drawings. In the drawings, the same components throughout the description of Embodiments are designated by the same reference numerals.

### Basic Concept/Basic Configuration

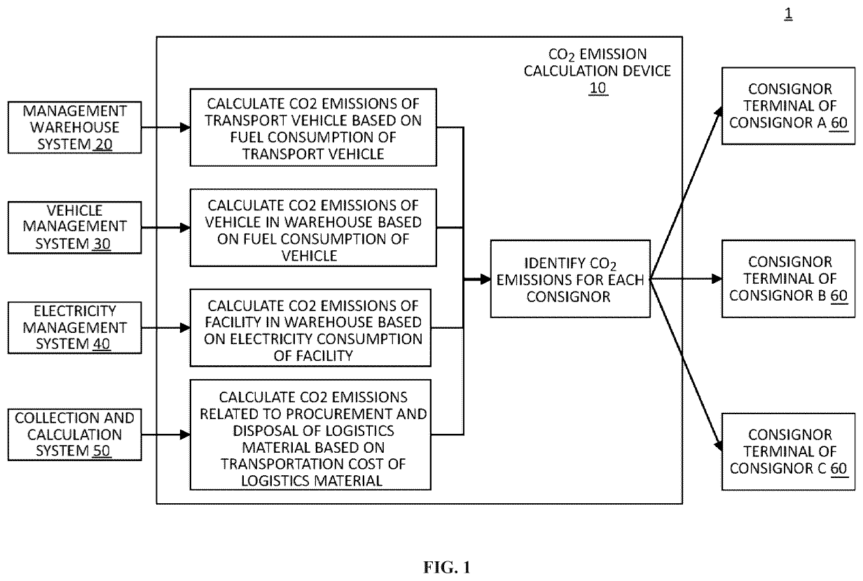

FIG. 1 is a diagram for explaining the overview of the CO₂ emission calculation system 1 according to an Embodiment of the present disclosure. As shown in FIG. 1, the CO₂ emission calculation system 1 includes a warehouse management system 20, a vehicle management system 30, an electricity management system 40, a collection and aggregation system 50, a CO₂ emission calculation device 10, and a consignor terminal 60. The consignor terminal 60 is a terminal for each consignor who assigns a logistics service. Although FIG. 1 shows three terminals 60: the consignor terminal 60 of the consignor A, the consignor terminal 60 of the consignor B, and the consignor terminal 60 of the consignor C. However, any number of terminals can be used as long as at least one terminal is used.

The CO₂ emission calculation device 10, the warehouse management system 20, the vehicle management system 30, the electricity management system 40, the collection and aggregation system 50, and the consignor terminal 60 are connected among each other through a network. In this Embodiment, the warehouse management system 20, the vehicle management system 30, the electricity management system 40, the collection and aggregation system 50, and the CO₂ emission calculation device 10 are each implemented as a cloud server, which may also be implemented on premises.

In this Embodiment, the CO₂ emission calculation device 10 is described as a separate device from the warehouse management system 20, the vehicle management system 30, the electricity management system 40, and the collection and aggregation system 50. However, the functions of the CO₂ emission calculation device 10, which will be described later, may be included in any of the warehouse management system 20, the vehicle management system 30, the electricity management system 40, or the collection and aggregation system 50, and the CO₂ emission calculation device 10 may be omitted.

“Warehouse management system” is abbreviated as WMS. The warehouse management system or WMS 20 manages receiving, inventory, and shipping of an item consigned by the consignor. The warehouse management system 20 records the ship notice information, which contains information related to transportation of a shipped item, and transmits this ship notice information to the CO₂ emission calculation device 10 periodically (e.g., once a month).

The vehicle management system 30 manages operation of a vehicle (e.g., forklift, towing vehicle) used in a warehouse site. The vehicle management system 30 records operation information, which contains the fuel consumption of a vehicle used in the warehouse site, and transmits this operation information to the CO₂ emission calculation device 10 periodically (e.g., once a month).

The electricity management system 40 manages electricity used for a warehouse facility. The electricity management system 40 records electricity consumption information, which contains electricity consumed by the warehouse facility, and transmits this electric consumption information to the CO₂ emission calculation device 10 periodically (e.g., once a month).

The collection and aggregation system 50 manages trade related to procurement and disposal of a material (e.g., packing material) used for logistics. The collection and aggregation system 50 records trade information, which contains a payment amount for a transportation fee related to procurement and disposal of a material used for logistics (hereinafter also referred to as “logistics material”), and transmits this trade information to the CO₂ emission calculation device 10 periodically (e.g., once a month).

The CO₂ emission calculation device 10 calculates CO₂ emissions related to logistics for each consignor. The CO₂ emissions related to logistics are the total of CO₂ emissions produced from transportation of an item, travel of an item in a warehouse, use of a warehouse facility, and processing for procurement or disposal of a material used for an item.

Specifically, the CO₂ emission calculation device 10 calculates CO₂ emissions from the amount of fuel consumed by a transport vehicle based on the ship notice information acquired from the warehouse management system 20. The CO₂ emission calculation device 10 also calculates CO₂ emissions from the amount of fuel consumed by a vehicle in a warehouse based on the operation information acquired from the vehicle management system 30. The CO₂ emission calculation device 10 also calculates CO₂ emissions from the amount of electricity consumed by a facility in a warehouse based on the electricity consumption information acquired from the electricity management system 40. The CO₂ emission calculation device 10 also calculates CO₂ emissions from the transportation cost of a logistics material based on the trade information acquired from the collection and aggregation system 50.

The CO₂ emission calculation device 10 identifies the consignor that produced each calculated CO₂ emissions and specifies the CO₂ emissions for each consignor. Then, the CO₂ emission calculation device 10 transmits the CO₂ emissions of a consignor to the consignor terminal 60.

Accordingly, the CO₂ emission calculation system can calculate CO₂ emissions produced from transportation of a material used for an item, CO₂ emissions produced from transportation of an item, CO₂ emissions produced from travel of an item in a warehouse, and CO₂ emissions produced from electricity consumed in a warehouse storing an item. Then, the CO₂ emission calculation system can identify the consignor that produced the calculated CO₂ emissions, allowing for accurate calculation of CO₂ emissions produced from logistics for each consignor.

### Functional Configuration

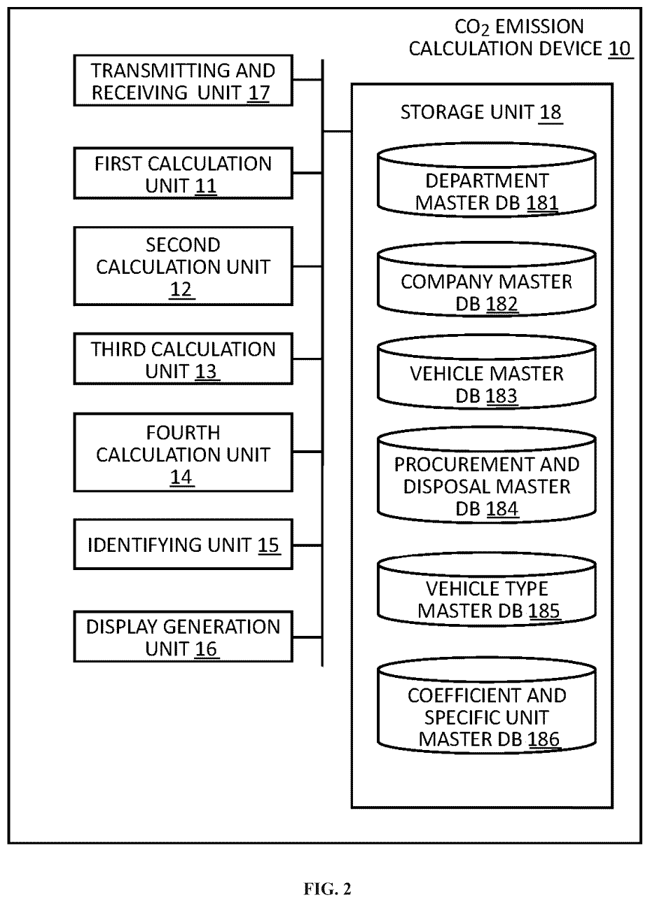

FIG. 2 is a diagram for explaining the functional configuration of the CO₂ emission calculation device 10 according to an Embodiment of the present disclosure. The CO₂ emission calculation device 10 includes a first calculation unit 11, a second calculation unit 12, a third calculation unit 13, a fourth calculation unit 14, an identifying unit 15, a display generation unit 16, a transmitting and receiving unit 17, and a storage unit 18.

The transmitting and receiving unit 17 transmits and receives data to and from the warehouse management system 20, the vehicle management system 30, the electricity management system 40, the collection and aggregation system 50, and the consignor terminal 60. In this Embodiment, since the CO₂ emission calculation device 10 is a cloud server, the storage unit 18 is composed of a cloud storage or a distributed ledger but may be composed of a hard disk, a semiconductor memory, a storage medium, a memory card, etc.

The first calculation unit 11 calculates CO₂ emissions produced from transportation related to procurement and disposal of a logistics material based on the transportation cost of the logistics material. The logistics material refers to a consumable necessary for an item, for example, packing material such as cardboard or cushioning material, string, and shipping tags. The transportation cost refers to a transportation cost generated when a logistics material is procured and disposed to and from a warehouse.

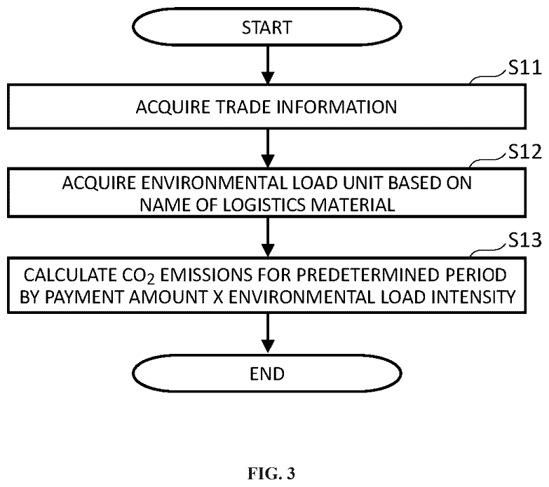

FIG. 3 shows the flow of the CO₂ emission calculation process of the first calculation unit 11 (hereinafter also referred to as “first calculation process”) according to this Embodiment. The function of the first calculation unit 11 is explained in detail below with reference to FIG. 3 showing the first calculation process.

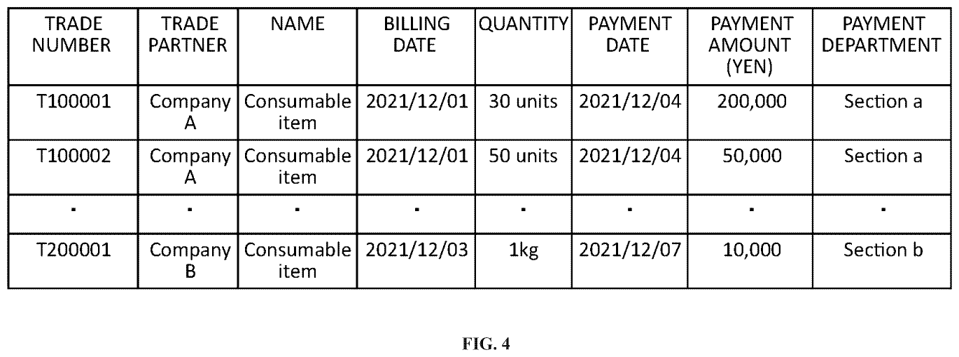

The first calculation unit 11 first acquires trade information of a logistics material from the collection and aggregation system 50 through the transmitting and receiving unit 17 (S11). FIG. 4 schematically shows trade information according to this Embodiment. The trade information contains information indicating a trade number identifying trade of a logistics material, a trade business partner, the name of a logistics material, a billing date for payment, the quantity of a logistics material, a payment date, a payment amount (yen), a payment department, etc., as shown in FIG. 4. The payment department is a section being in charge of payment of trade of a logistics material, and each paying department is assigned to a consignor.

Next, the first calculation unit 11 acquires an environmental load intensity from the procurement and disposal master database (hereinafter also referred to as “procurement and disposal master DB”) 184 in the storage unit 18 based on the name of a logistics material in the acquired trade information (S12). The procurement and disposal master DB 184 is a database in which the name of a logistics material is recorded in association with an environmental load intensity. The procurement and disposal master DB is generated based on, for example, Embodied Energy and Emission Intensity Data for Japan Using Input-Output Tables (available from National Institute for Environmental Studies) and Joint guidelines on methods for calculating carbon dioxide emissions in the logistics sector Ver. 3.1 (available from Ministry of Economy and Trade and Industry and Ministry of Land, Infrastructure, Transport and Tourism).

Next, the first calculation unit 11 calculates CO₂ emissions produced from transportation related to procurement and disposal of a logistics material by a fee method. Specifically, the CO₂ emissions are calculated by multiplying the payment amount of the trade information for a predetermined period (e.g., one month), which is acquired in S11 by the environmental load intensity, which is acquired in S12 (S13). The calculated CO₂ emissions are associated with the payment department of the trade information.

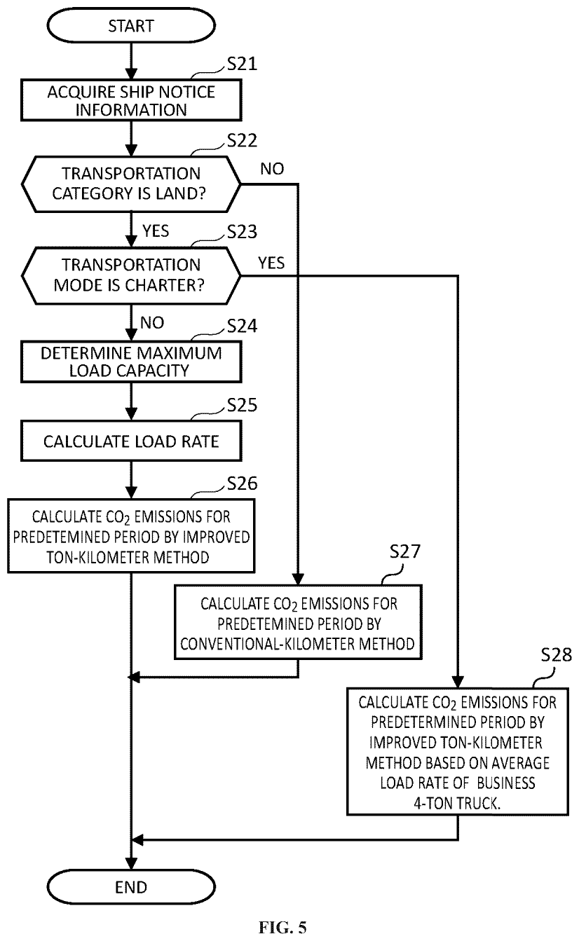

The second calculation unit 12 calculates CO₂ emissions produced from transportation of an item based on the fuel consumption of a transport vehicle transporting an item. The transport vehicle refers to a vehicle, a ship, a train, and an aircraft. FIG. 5 shows the flow of the CO₂ emission calculation process of the second calculation unit 12 (hereinafter also referred to as “second calculation process”) according to this Embodiment. The function of the second calculation unit 12 is explained in detail below with reference to FIG. 5 showing the second calculation process.

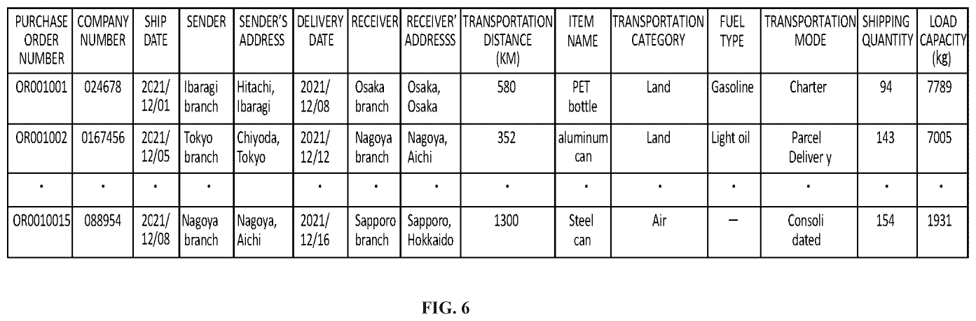

The second calculation unit 12 first acquires ship notice information from the warehouse management system 20 through the transmitting and receiving unit 17 (S21). FIG. 6 schematically shows ship notice information according to this Embodiment. The ship notice information contains information indicating a purchase order number identifying a purchase order, a company number identifying a consignor, the ship date of an ordered product, the sender of an ordered item, the address of a sender, the delivery date of an ordered item, the receiver of an ordered item, a receiver's address, the transportation distance from a sender to a receiver, the item name of an ordered item, a transportation category, the fuel type of a transport vehicle used for transportation, a transportation mode, a shipping quantity, a load capacity (kg), etc.

The transportation category refers to the type of transportation used for transporting an item, which is road, air, rail, or sea. The transportation mode refers to a transport method, which includes “charter,” where a single transport vehicle is chartered to load and transport only the item of a specific consignor; “consolidated,” where a single transport vehicle loads and transports the items of multiple consignors together; “route delivery”, where a transport vehicle transports an item between companies through predetermined multiple bases and delivery routes; and “parcel delivery,” where a transport vehicle transports an item from a company to a general consumer through predetermined multiple bases and delivery routes.

Next, the second calculation unit 12 judges whether or not the transportation category acquired in S21 is “road” (S22). If the transportation category is “road,” the process proceeds to S23. On the other hand, if the transportation category is not “road,” that is, if the transportation category is air, rail, or sea, the process proceeds to S27. Then, the second calculation unit 12 judges whether or not the transportation mode acquired in S21 is “charter” (S23). If the transportation mode is “charter,” the process proceeds to S24. On the other hand, if the transportation mode is not “charter,” that is, if the transportation mode is consolidated, route delivery, or parcel delivery, the process proceeds to S28.

Next, the second calculation unit 12 references the vehicle type master database (hereinafter also referred to as “vehicle type master DB”) 185 stored in the storage unit 18, estimates the vehicle type based on the load capacity of the ship notice information, which is acquired in S21, and determines the maximum load capacity (S24). The vehicle type master DB 185 stores a load capacity in association with a vehicle type and the maximum load capacity of this vehicle type. Then, the second calculation unit 12 calculates the load rate of a transport vehicle by dividing the load capacity in the ship notice information, which is acquired in S21, by the maximum load capacity, which is acquired in S24 (S25).

Next, the second calculation unit 12 calculates CO₂ emissions for a predetermined period by using the improved ton-kilometer method (S26), which is one of the methods for calculating CO₂ emissions, based on the fuel type and the transportation distance in the ship notice information acquired in S21, the load rate calculated in S25, and the maximum load capacity determined in S24. Specifically, the second calculation unit 12 calculates CO₂ emissions for a predetermined period by using the formulas (1) and (2), which are calculation formulas for the improved ton-kilometer method based on the fuel type and the transportation distance in the ship notice information acquired in S21, the load rate calculated in S25, and the maximum load capacity determined in S24. The calculated CO₂ emissions are associated with the company number in the ship notice information.

As described above, the second calculation unit 12 acquires the transportation distance from the ship notice information in S26. However, if the ship notice information does not contain a transportation distance, the second calculation unit 12 references the distance master (not shown) previously provided in the storage unit 18 to acquire a transportation distance based on the ship notice information. The distance master is a database in which a transportation distance is associated with the transportation category, the sender's address, and the receiver's address in the ship notice information. The second calculation unit 12 selects a condition from the distance master to match or approximate the relationship among the transportation category, the sender's address, and the receiver's address in the ship notice information and then acquires this condition as a transportation distance.

$${CO}_{2} emissions ( t - {CO}_{2} ) = Transportation ton kilometer ( Ton - kilometer ) \times Improved ton - kilometer method fuel consumption unit ( 1 / Ton - kilometer ) \times 1 / 1000 \times Unit calorific value ( Gj / kl ) \times Emission factor ( t - C / Gj ) \times 44 / 12 ( t - {CO}_{2} / t - C ) \qquad Formula ( 1 )$$

$$Transportation ton kilometer = Load capacity ( kg ) / 1000 \times Transport distance \qquad Formula ( 2 )$$

The improved ton-kilometer method fuel consumption unit is the amount of fuel used per transport ton-kilometer, which is acquired from the coefficient and specific unit master database (hereinafter also referred to as “coefficient and specific unit master DB”) 186 based on the fuel type, a maximum load capacity, and a load rate. In the coefficient and specific unit master DB 186, the improved ton-kilometer method fuel consumption unit table, in which a specific unit is associated with a fuel type, a maximum load capacity, and a load rate. This table is generated based on the calculation method guideline for CO₂ emissions in the logistics sector by the Ministry of Economy, Trade and Industry and the Ministry of Land, Infrastructure, Transport and Tourism.

To determine the specific unit more accurately, values are substituted into the following formula (3) to calculate the specific unit.

$$In case of fuel type “ light oil ” : ln y = 2.71 - 0.812 ln ( x / 100 ) - 0.654 ln z \qquad Formula ( 3 )$$

$$In case of fuel type “ gasoline ” : ln y = 2.67 - 0.927 ln ( x / 100 - 0.648 ln z$$

$$y : Fuel use per transport ton kilometer ( 1 / t \cdot km )$$

$$x : Load rate ( \% )$$

$$z : Maximum load capacity$$

The unit heating value, which is a heating value per unit amount, and the emission factor, which is a carbon emission amount per unit heating value, are acquired from the coefficient and specific unit master DB 186 based on a fuel type. The coefficient and specific unit master DB 186 stores a table in which a fuel type is associated with a unit heating value and an emission factor. This table is generated based on the Energy Conservation Act Notice and the Enforcement Order and Ordinance of the Act on Promotion of Global Warming Countermeasures.

Returning to FIG. 5, the second calculation unit 12 calculates CO₂ emissions for a predetermined period based on the transportation category, the load capacity, and the transportation distance in the ship notice information acquired in S21 by using the conventional ton-kilometer method, which is one of the methods for calculating CO₂ emissions (S27). Specifically, the second calculation unit 12 calculates CO₂ emissions for a predetermined period based on the transportation category, the load capacity, and the transportation distance in the ship notice information acquired in S21 by using the following formula (4) and the above-mentioned formula (2). The calculated CO₂ emissions are associated with the company number in the ship notice information.

$${CO}_{2} emissions ( t - {CO}_{2} ) = Transport ton kilometer ( Ton - kilometer ) \times Conventional ton - kilometer method {CO}_{2} emission intensity ( g - {CO}_{2} / Ton - kilometer ) \times 1 / 1,000,000 ( t - {CO}_{2} / g - {CO}_{2} ) \qquad Formula ( 4 )$$

The conventional ton-kilometer method CO₂ emission intensity is a fuel use per transport ton kilometer, which is acquired from the coefficient and specific unit master DB 186 based on the transportation category. The coefficient and specific unit master DB 186 stores the conventional ton-kilometer method CO₂ emission intensity table, in which a transportation category is associated with a specific unit. This table is generated based on information on a vehicle, which is disclosed by the Ministry of Land, Infrastructure, Transport and Tourism and information on a railway, a vessel on a domestic route, and a domestic airline, which is disclosed by the Ministry of the Environment and the Ministry of Economy, Trade and Industry.

Returning to FIG. 5, the second calculation unit 12 calculates CO₂ emissions for a predetermined period based on a maximum load capacity of 4,000 kg and a load rate by using the above-mentioned improved ton-kilometer method (S28). Specifically, the second calculation unit 12 calculates CO₂ emissions for a predetermined period by using the formulas (1) and (2), which are calculation formulas for the improved ton-kilometer method based on the fuel type and the transportation distance in the ship notice information acquired in S21, a maximum load capacity of 4,000 kg, and a load rate of 62%. The calculated CO₂ emissions are associated with the company number in the ship notice information.

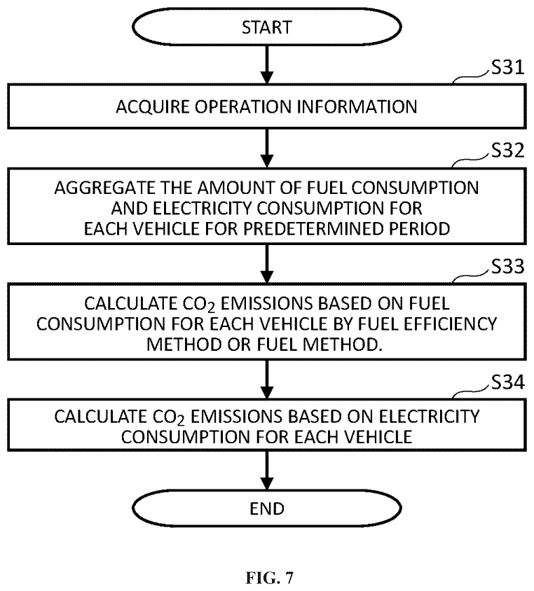

The third calculation unit 13 calculates CO₂ emissions produced from travel of an item in a warehouse based on fuel consumption of a vehicle used for travel of the item. FIG. 7 shows the flow of the CO₂ emission calculation process of the third calculation unit 13 (hereinafter also referred to as “third calculation process”) according to this Embodiment. The function of the third calculation unit 13 is explained in detail below with reference to FIG. 7 showing the third calculation process.

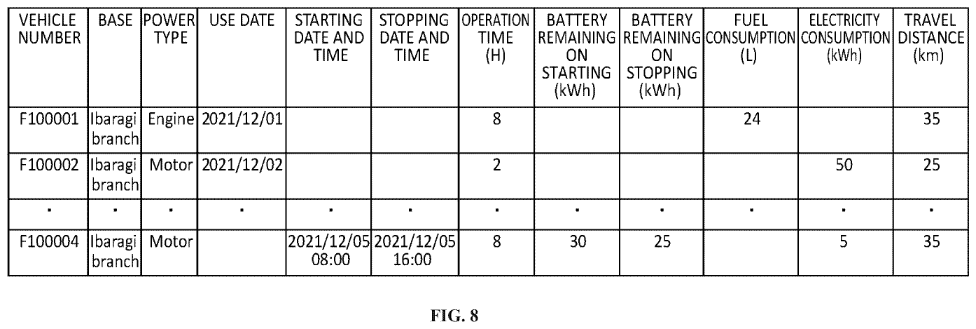

The third calculation unit 13 first acquires operation information from the vehicle management system 30 through the transmitting and receiving unit 17 (S31). FIG. 8 schematically shows operation information according to this Embodiment. The operation information contains information on a vehicle number for identifying a vehicle in a warehouse, the base of a vehicle, the power type of a vehicle, the use date of a vehicle, the starting date and time of a vehicle, the stopping date and time of a vehicle, an operating time, a battery remaining on starting (kWh), a battery remaining on stopping (kWh), a fuel consumption amount (L), an electricity consumption (kWh), a travel distance (km), etc.

The operation information may be manually input by a worker who has operated a vehicle or automatically input by connecting an ECU and a vehicle management device that are installed in a vehicle and connected with various sensors through a network. For the operation information that is manually input, a worker inputs a vehicle number, a base, a power type, a use date, an operating time, a fuel consumption amount (L), an electricity consumption (kWh), and a travel distance (km).

For the operation information automatically input, if the power type of a vehicle is an engine, the ECU provides the vehicle number, the base, the power type, the starting and the stopping dates and times acquired based on detection of an ignition key being turned ON/OFF, a fuel injection amount during the period after an ignition key is turned to ON until to OFF, and a travel distance (km). The vehicle management system 30 calculates an operating time based on the acquired starting and stopping dates and times, totals the fuel injection amount during the period after an ignition key is turned to ON until to OFF to calculate a fuel consumption, and combines this calculated fuel consumption with the acquired information to generate operation information.

If the power type of a vehicle is a motor, the ECU provides the vehicle number, the base, the power type, the starting and the stopping dates and times acquired based on detection of the switch being turned ON/OFF, and the travel distance (km). The vehicle management system 30 calculates the operation time based on the acquired starting and stopping dates and times, estimates the electricity consumption by multiplying the calculated operation time by the previously set rated output of the vehicle, and combines the estimated rated output with the acquired information to generate the operation information. If the vehicle is equipped with a measurement device for a battery remaining, the electricity consumption may be determined based on the remaining estimated from the voltage by this measurement device.

Returning to FIG. 7, the third calculation unit 13 aggregates fuel consumption and electricity consumption for each vehicle for a predetermined period based on the operation information acquired in S31 (S32). Next, the third calculation unit 13 calculates CO₂ emissions for each vehicle by using the fuel method, which is one of the methods for calculating CO₂ emissions, based on the fuel consumption aggregated in S32. Specifically, the third calculation unit 13 calculates CO₂ emissions based on the fuel consumption aggregated in S32 by using the following formula (5). The calculated CO₂ emissions are associated with the vehicle number in the operation information. The unit heating value and the emission factor are as described above.

For the operation information with unknown fuel consumption, the third calculation unit 13 calculates CO₂ emissions separately by using the fuel consumption method, which is one of the methods for calculating CO₂ emissions, based on the travel distance and the fuel efficiency, and then combines the calculated CO₂ emissions with those based on a fuel consumption (S33). Specifically, the third calculation unit 13 calculates CO₂ emissions based on the travel distance and the fuel efficiency by using the following formulas (5) and (6). The calculated CO₂ emissions are associated with the vehicle number in the operation information. For a fuel efficiency, a measured value or a fuel efficiency previously set according to the vehicle type and the maximum load capacity is used.

$${CO}_{2} emissions ( t - {CO}_{2} ) = Fuel consumption ( kl ) \times Unit calorific value ( Gj / kl ) \times Emission factor ( t - C / Gj ) \times 44 / 12 ( t - {CO}_{2} / t - C ) \qquad Formula ( 5 )$$

$$Fuel consumption ( kl ) = Travel distance ( km ) / Fuel efficirncy ( km / 1 ) \times 1 / 1000 \qquad Formula ( 6 )$$

Next, the third calculation unit 13 calculates CO₂ emissions by using the following formula (7) based on the electricity consumption aggregated in step S32. For the operation information with unknown electricity consumption, the third calculation unit 13 calculates CO₂ emissions separately by using the fuel efficiency method based on the travel distance and the fuel efficiency, and then combines the calculated CO₂ emissions with those based on the electricity consumption (S34). The calculated CO₂ emissions are associated with the vehicle number in the operation information.

$${CO}_{2} emissions ( t - {CO}_{2} ) = Electricity consumption ( kWh ) \times Emission factor ( t - C / Gj ) \qquad ( 7 )$$

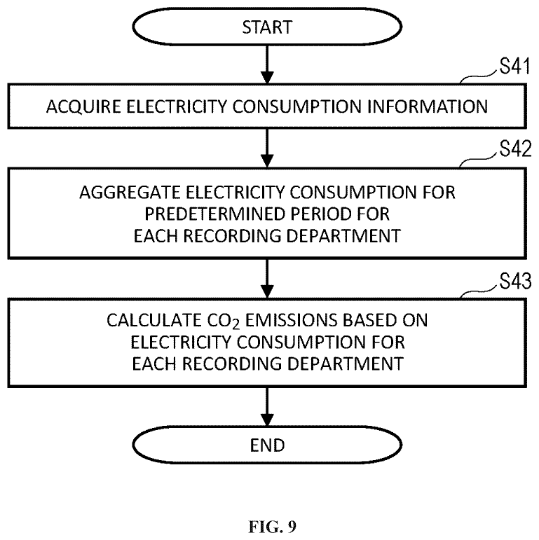

The fourth calculation unit 14 calculates CO₂ emissions produced from management of an item in a warehouse based on electricity consumption of a facility in the warehouse. FIG. 9 is the flow of the CO₂ emission calculation process of the fourth calculation unit 14 (hereinafter also referred to as “fourth calculation process”) according to this Embodiment. The function of the fourth calculation unit 14 is explained in detail below with reference to FIG. 9 showing the fourth calculation process.

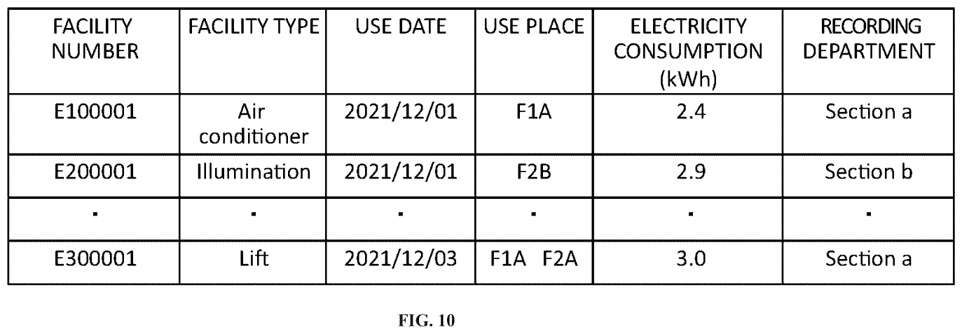

The fourth calculation unit 14 first acquires electricity consumption information from the electricity management system 40 through the transmitting and receiving unit 17 (S41). FIG. 10 schematically shows electricity consumption information according to this Embodiment. The electricity consumption information contains information on a facility number identifying a facility in a warehouse, a facility type indicating the type of a facility, the use date of a facility, the use location of a facility, the electricity consumption (kWh) of a facility, and a recording department. The recording department is a section that records electricity consumption information, and each recording department is assigned to a consignor.

Next, the fourth calculation unit 14 aggregates electricity consumption for a predetermined for each recording department based on the electricity consumption information acquired in S41 (S42). Then, the fourth calculation unit 14 calculates CO₂ emissions by using the above-mentioned formula (7) based on the electricity consumption aggregated in S42 (S43). The calculated CO₂ emissions are associated with the recording department in the operation information.

The identifying unit 15 identifies the consignor that produced the CO₂ emissions calculated by the first calculation unit 11, the second calculation unit 12, the third calculation unit 13, and the fourth calculation unit 14. Specifically, the identifying unit 15 references the CO₂ emissions calculated by the first calculation unit 11 and the department master database (hereinafter also referred to as “department master DB”) 181 in which a payment department is recorded in association with a consignor assigned to the payment department, to identify the consignor.

The identifying unit 15 also references the CO₂ emissions calculated by the second calculation unit 12 and the company master database (hereinafter also referred to as “company master DB”) 182 in which a company number is recorded in association with a consignor company, to identify the consignor. The identifying unit 15 also references the CO₂ emissions calculated by the third calculation unit 12 and the vehicle master database (hereinafter referred to as “vehicle master DB”) 183 in which a vehicle number is recorded in association with a consignor company that owns the vehicle, to identify the consignor.

The identifying unit 15 also references the CO₂ emissions calculated by the fourth calculation unit 14 and the department master DB 181 in which a recording department is recorded in association with a consignor company assigned to the recording department, to identify the consignor.

The identifying unit 15 aggregates the CO₂ emissions for each consignor. The CO₂ emissions aggregated for each consignor are recorded in the storage unit 18.

The display generation unit 16 acquires the CO₂ emissions of a consignor from the storage unit 18 in response to a request from the consignor terminal 60, transmits the acquired CO₂ emissions through the transmitting and receiving unit 17 to the consignor terminal 60 to cause the consignor terminal 60 to display the transmitted CO₂ emissions.

The functional configuration of this system described above is merely an example, which may divide a single functional block (database and functional processing unit) or combine multiple functional blocks into a single functional block. Each functional processing unit is realized by a computer program stored in a storage device (storage unit) such as a ROM (Read Only Memory), a flash memory, an SSD (Solid State Drive), or a hard disk. The computer program (e.g., core software, an application causing a CPU to execute the above-mentioned various processes) is read out and executed by the CPU (Central Processing Unit). In other words, each functional processing unit is realized when the computer program reads and writes necessary data such as tables from a database (DB) stored in a storage device or a storage area on a memory. In some cases, each functional processing unit is realized by controlling the related hardware (e.g., input and output device, display device, communication interface device).

### Process Flow

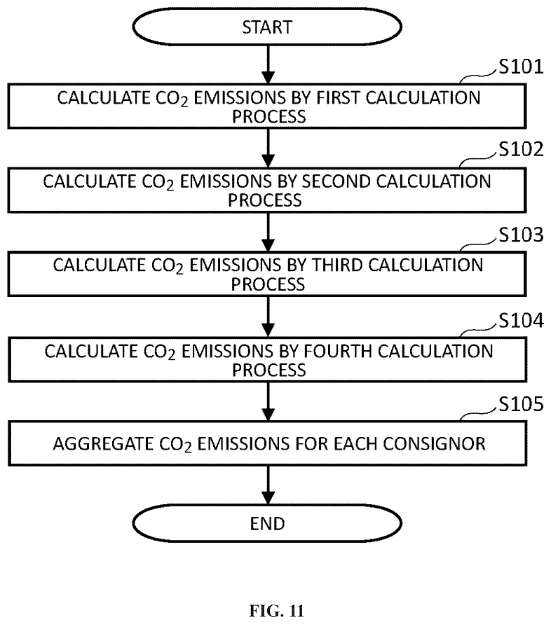

The CO₂ emission calculation process of the CO₂ emission calculation system 1 according to an Embodiment of the present disclosure is explained below with reference to FIG. 11. This process is executed by the CO₂ emission calculation device 10.

The first calculation unit 11 executes the first calculation process shown in FIG. 3 based on the trade information for a predetermined acquired from the collection and aggregation system 50, calculates CO₂ emissions based on the transportation cost of a logistics material, and associates the calculated CO₂ emissions with the payment department (S101). Then, the second calculation unit 12 executes the second calculation process shown in FIG. 5 based on the ship notice information for a predetermined period acquired from the warehouse management system 20, calculates CO₂ emissions based on the fuel consumption of a transport vehicle transporting an item, and associates the calculated CO₂ emissions with the company number (S102).

Next, the third calculation unit 13 executes the third calculation process shown in FIG. 7 based on the operation information for a predetermined period acquired from the vehicle system 30, calculates CO₂ emissions based on the fuel consumption and the electricity consumption of a vehicle used for traveling an item in a warehouse, and associates the calculated CO₂ emissions with the vehicle number (S103). Next, the fourth calculation unit 14 executes the fourth calculation process shown in FIG. 9 based on the electricity consumption information for a predetermined period acquired from the electricity management system 40, calculates CO₂ emissions based on the electricity consumption of a facility in a warehouse, and associates the calculated CO₂ emissions with the recording department (S104).

Then, the identifying unit 15 identifies the consignor that produced the CO₂ emissions calculated in S101 to S104 and aggregates the CO₂ emissions for each consignor (S105). The aggregated CO₂ emissions are stored in the storage unit 18, and the CO₂ emissions of the consignor of a consignor terminal 60 are transmitted to the consignor terminal 60 in response to a request from the consignor terminal 60. The steps S101 to S104 may be performed in a different order or not simultaneously. Additionally, all the steps S101 to S104 are not necessarily performed.

As described above, the CO₂ emission calculation system can calculate CO₂ emissions produced from transportation of a material used for an item, CO₂ emissions produced from transportation of an item, CO₂ emissions produced from travel of an item in a warehouse, and CO₂ emissions produced from electricity consumed in a warehouse storing an item. Then, the CO₂ emission calculation system can identify the consignor that produced the calculated CO₂ emissions, allowing for accurate calculation of CO₂ emissions produced from logistics for each consignor. The calculated CO₂ emissions are presented to a consignor to visualize CO₂ emissions in logistics so that the consignor can be aware of reducing CO₂ emissions.

### Modifications

(1) The CO₂ emission calculation device 10 may acquire a fuel consumption or a fuel efficiency and a travel distance directly from the ECU (Electronic Control Unit) of a vehicle not through the vehicle management system 30. The vehicle is equipped with multiple ECUs that control the engine, the instruments, etc. The ECUs record the fuel consumption, the fuel efficiency, and the travel distance, (in the case of an electric vehicle, the electricity consumption, the electricity efficiency, the travel distance), etc. The ECUs are intercommunicatively connected among each other through a CAN (Controller Area Network). The CAN is connected to a communication device that connects to the Internet, and the ECUs are connected to the CO₂ emission calculation device 10 through the communication device.

The vehicle is equipped with a GNSS (Global Navigation Satellite System), and the optimal route is searched and suggested based on the delivery plan output by a TMS (Transport Management System) when the driver sets a stopover and a destination. If the driver approves this route, the GNSS outputs a signal related to the approval to an ECU, and the ECU records this approval. When the current coordinates of the vehicle reach the stopover or the destination, the GNSS notifies other ECUs with a signal, and the ECUs record this notification.

When the vehicle finally arrives at the destination, the ECUs calculate and record the fuel consumption, the fuel efficiency, and the actual travel distance from the starting point to the stopover or the destination. The ECU transmits this recorded information to the CO₂ emission calculation device 10 through a communication device.

(2) The CO₂ emission calculation device 10 may calculate CO₂ emissions produced at a base based on consignor's base information and cause the consignor terminal 60 to display the calculated CO₂ emissions. Each of the department master DB 181, the company master DB 182, and the vehicle master DB 183 stores a company name and a base name in association with a department, a company number, and a vehicle number. The identifying unit 15 identifies the consignor and the consignor's base that produced the CO₂ emissions calculated by the first to fourth calculation units 11 to 14. Then, the identifying unit 15 aggregates the CO₂ emissions for each consignor's base.

This enables calculation of CO₂ emissions based on the fuel consumption of transport vehicles departing from the same base, the fuel consumption of vehicles belonging to this base, the electricity consumption at this base, and the transportation cost of consumables/waste at this base. Consequently, this enables calculation of the CO₂ emissions for each consignor's base.

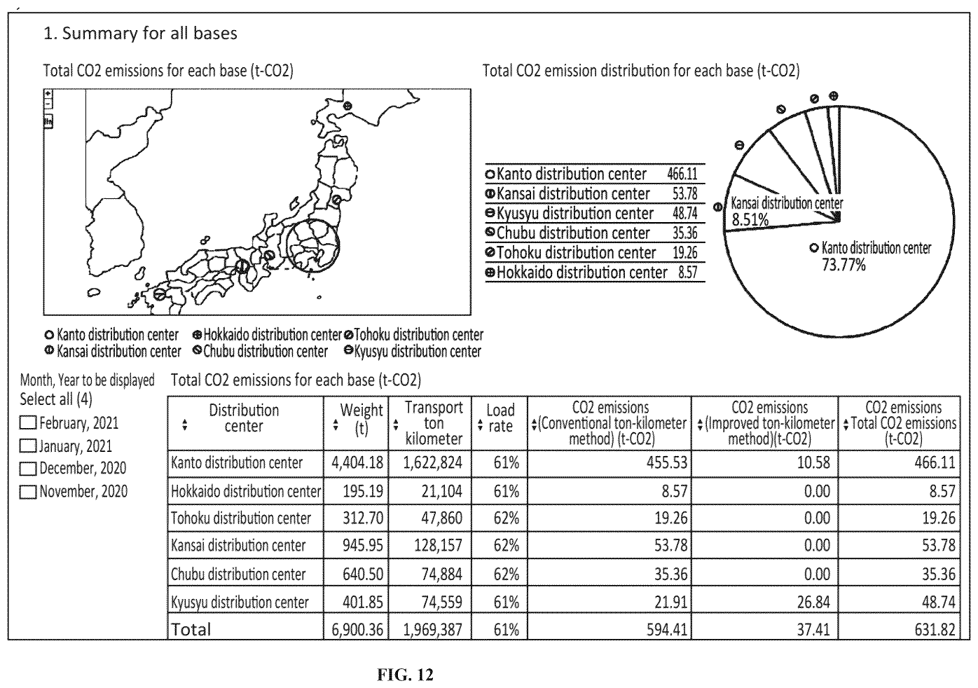

The display generation unit 16 generates a table based on the CO₂ emissions aggregated for each consignor's base by the identifying unit 15 and transmits this table to the consignor terminal 60. The display generation unit 16 also uses map information to generate a map that displays a circle centered on the coordinates of each location. The size of the circle corresponds to the CO₂ emissions. The display generation unit 16 then transmits the map to the consignor terminal 60. The display generation unit 16 may transmit both the above-mentioned table and map to the consignor terminal 60. FIG. 12 shows an example display on a consignor terminal 60.

(3) The second calculation unit 12 may take into account the fuel consumption of a vehicle for calculating the CO₂ emissions when the transport vehicle is a train. When the transport vehicle is a rail train, vehicles are used to transport an item from a sender to a rail station and from a station to a receiver. In this case, the CO₂ emissions can be calculated more accurately by taking into account the fuel consumption of the vehicles.

The present disclosure is described using the above-mentioned Embodiments, but the technical scope of the present disclosure is not limited to the scope described in these Embodiments. It is apparent to those skilled in the art that various modifications or improvements can be made to the above-mentioned Embodiments. Furthermore, it is clear from the description of the claims that such modified or improved embodiments can also be included within the technical scope of the present disclosure. In the above-mentioned Embodiments, the present disclosure is described as a disclosure of a product, specifically a CO₂ emission calculation system. However, in the present disclosure, it can also be regarded as a disclosure of a method executed by the CO₂ emission calculation system or as a program causing the CO₂ emission calculation to function as various means.

### DESCRIPTION OF REFERENCE NUMERALS

1: CO₂ emission calculation system, 10: CO₂ emission calculation device, 11: first calculation unit, 12: second calculation unit, 13: third calculation unit, 14: fourth calculation unit, 15: identifying unit, 16: display generation unit, 17: transmitting and receiving unit, 18: storage unit, 181: department master DB, 182: company master DB, 183: vehicle master DB, 184: procurement and disposal master DB, 185: vehicle type master DB, 186: coefficient and specific unit master DB, 20: warehouse management system, 30: vehicle management system, 40: electricity management system, 50: collection and aggregation system, 60: consignor terminal.

1. A CO₂ emission calculation system that calculates CO₂ emissions related to logistics, comprising:
a first calculation unit that calculates CO₂ emissions based on a transportation cost for a material used for the logistics; and
an identifying unit that identifies a consignor that produced the calculated CO₂ emissions.

2. The CO₂ emission calculation system according to claim 1, wherein
the first calculation unit calculates CO₂ emissions for each payment department that manages trade for the material, and
the identifying unit further identifies a consignor that produced the calculated CO₂ emissions based on department information containing the consignor assigned to each the payment department.

3. The CO₂ emission calculation system according to claim 1, further comprising:
a second calculation unit that calculates CO₂ emissions based on energy consumed by transportation of an item;
a third calculation unit that calculates CO₂ emissions based on energy consumed by travel of an item in a warehouse site; and
a fourth calculation unit that calculates CO₂ emissions based on energy consumed by management of the item in the warehouse site, wherein
the identifying unit identifies a consignor that produced the CO₂ emissions calculated by each of the calculation units.

4. The CO₂ emission calculation system according to claim 3, wherein
the second calculation unit calculates CO₂ emissions for each item,
the third calculation unit calculates CO₂ emissions for each vehicle used in travel of the item,
the fourth calculation unit calculates CO₂ emissions for each recording department that recorded energy consumed by management of the item, and
the identifying unit identifies a consignor that produced CO₂ emissions calculated by the second calculation unit based on shipping information containing a consignor for each the item, identifies a consignor that produced CO₂ emissions calculated by the third calculation unit based on vehicle information containing a consignor for each the vehicle, and identifies a consignor that produced CO₂ emissions calculated by the fourth calculation unit based on recording department information containing a consignor assigned to each the recording department.

5. The CO₂ emission calculation system according to claim 3, wherein
the second calculation unit acquires information on the consumed energy from a device installed in a vehicle used for transportation of the item, and/or the third calculation unit acquires information on the consumed energy from a device installed in a vehicle used for travel of the item.

6. The CO₂ emission calculation system according to claim 1, further comprising a display unit that displays CO₂ emissions produced at a base based on base information of the identified consignor.

7. A method of executing a CO₂ emission calculation system that calculates CO₂ emissions related to logistics, comprising:
calculating CO₂ emissions based on a transportation cost for a material used for the logistics; and
identifying a consignor that produced the calculated CO₂ emissions.

8. A program causing a CO₂ emission calculation system that calculates CO₂ emissions related to logistics to function as:
a first calculation unit that calculates CO₂ emissions based on a transportation cost for a material used for the logistics; and
an identifying unit that identifies a consignor that produced the calculated CO₂ emissions.
